(19) United States
(12) Patent Application Publication
(10) Pub. No.: US 2016/0050529 A1
(43) Pub. Date: Feb. 18, 2016

(54) Location Information from a Mobile Device

(71) Applicant: Microsoft Corporation, Redmond, WA (US)

(72) Inventors: Amer A. Hassan, Kirkland, WA (US); Paul William Alexander Mitchell, Seattle, WA (US); Paul W. Garnett, Albany, NY (US)

(21) Appl. No.: 14/461,916

(22) Filed: Aug. 18, 2014

(51) Int. Cl. H04W 4/02; H04L 29/08; H04L 29/06

(52) U.S. Cl. CPC H04W 4/023; H04L 67/42; H04L 67/18

(57) ABSTRACT

Techniques for location information from a mobile device are described. According to various embodiments, a client device receives location information from a mobile end-user device, and utilizes the location information to estimate its own location. In at least some embodiments, location information is associated with a reliability value that indicates a general reliability of the location information. According to various embodiments, a client device may utilize its estimated location in different ways. For instance, the client device may share its location with other devices and/or applications, such as trusted devices, trusted applications and/or services, and so forth. A client device, for example, may share its estimated location with a social networking platform.

### BACKGROUND

Today's mobile devices provide users with a tremendous amount of portable functionality. For instance, smartphones, tablets, laptops, and so on, enable users to perform a variety of different tasks without being tied to a particular location. Since a user may move between locations, it can be useful to know where a user is located at a particular time, such as for providing location-specific content and services.

While there are existing ways to determine a user's location based on utilizing functionality of their mobile device, these current techniques suffer from a number of deficiencies. For instance, some techniques are inflexible and rely on the availability of information that may be transient, e.g., signals from cell towers for triangulation via communication with cellular base stations. Further, some techniques cannot adapt to changes in the types of location information that may be available at a particular location.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for location information from a mobile device are described. According to various embodiments, a client device receives location information from a mobile end-user device, and utilizes the location information to estimate its own location. In at least some embodiments, location information is associated with a reliability value that indicates a general reliability of the location information. According to various embodiments, a client device may utilize its estimated location in different ways. For instance, the client device may share its location with other devices and/or applications, such as trusted devices, trusted applications and/or services, and so forth. A client device, for example, may share its estimated location with a social networking platform.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein in accordance with one or more implementations.

FIG. 2 illustrates an example implementation of a location source table in accordance with one or more implementations.

FIG. 3 illustrates an example implementation scenario for receiving location information in accordance with one or more implementations.

FIG. 4 illustrates an example implementation scenario for querying for location information in accordance with one or more implementations.

FIG. 5 is a flow diagram that describes steps in a method for communicating location information in accordance with one or more implementations.

FIG. 6 is a flow diagram that describes steps in a method for estimating device location based on location information received from a source device in accordance with one or more implementations.

FIG. 7 is a flow diagram that describes steps in a method for ranking location information in accordance with one or more implementations.

FIG. 8 is a flow diagram that describes steps in a method for processing location information based on a reliability threshold in accordance with one or more implementations.

FIG. 9 is a flow diagram that describes steps in a method for mapping devices based on location information received from a source device in accordance with one or more implementations.

FIG. 10 illustrates an example proximity map in accordance with one or more implementations.

FIG. 11 illustrates an example system and computing device as described with reference to FIG. 1, which are configured to implement embodiments of techniques described herein.

### DETAILED DESCRIPTION

Overview

Techniques for location information from a mobile device are described. According to various implementations, a client device receives location information from a mobile end-user device, and utilizes the location information to estimate its own location. For instance, a client device may detect that a mobile end-user device is nearby, and thus may receive location information from the mobile end-user device to be used to determine its own location. A mobile end-user device, for instance, may transmit a location-related beacon that includes location information ascertained by the mobile end-user device. Alternatively or additionally, a client device may query the mobile end-user device for location information, and the mobile end-user device may return a query response with location information.

In at least some implementations, location information is associated with a reliability value that indicates a general reliability of the location information. A reliability value, for instance, may be based on conditions that pertain to how associated location information was determined. For instance, a reliability value may be assigned to location information based on attributes of a position information system that was leveraged to ascertain the location information. Generally, a position information system refers to a system that may be leveraged to provide position information, such as a Global Positioning System (GPS), a cellular network, a set of wireless access points (e.g., WiFi™ access points), and so forth.

In at least some implementations, location information that has a high reliability value may be ranked and/or prioritized over location information with a low reliability value. Further, location information with a low reliability may be ignored for purposes of ascertaining a location of a client device.

According to various implementations, a client device may utilize its estimated location in different ways. For instance, the client device may share its location with other devices and/or applications, such as trusted devices, trusted applications and/or services, and so forth. A client device, for example, may share its estimated location with a social networking platform, such as to be posted on a web page managed by the social networking platform.

In the following discussion, an example environment is first described that is operable to employ techniques described herein. Next, a section entitled “Example Implementation Scenarios” describes some implementation scenarios involving techniques discussed herein which may be employed in the example environment as well as in other environments. Following this, a section entitled “Location Information Reliability” describes example ways of determining and specifying location information accuracy in accordance with one or more embodiments. Next, a section entitled “Example Procedures” describes some example procedures for location information from a mobile device in accordance with one or more embodiments. Following this, a section entitled “Example Proximity Map” describes an example proximity map in accordance with one or more embodiments. Finally, a section entitled “Example System and Device” describes an example system and device that are operable to employ techniques discussed herein in accordance with one or more embodiments.

Example Environment

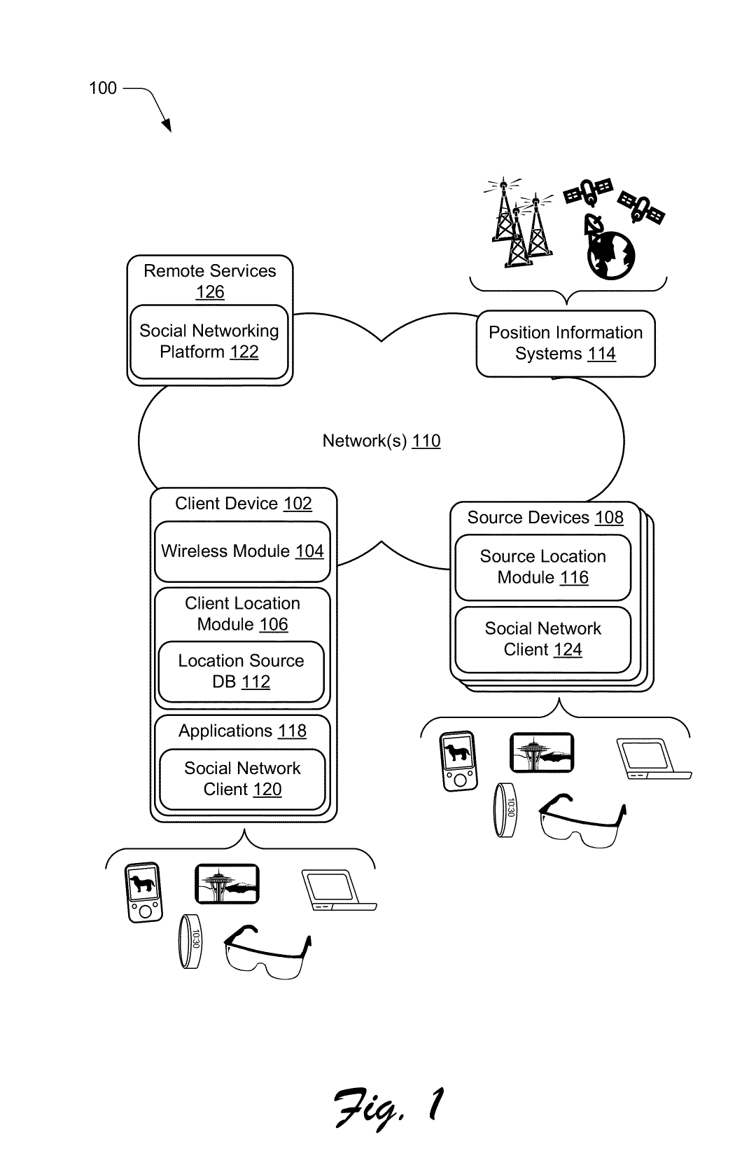

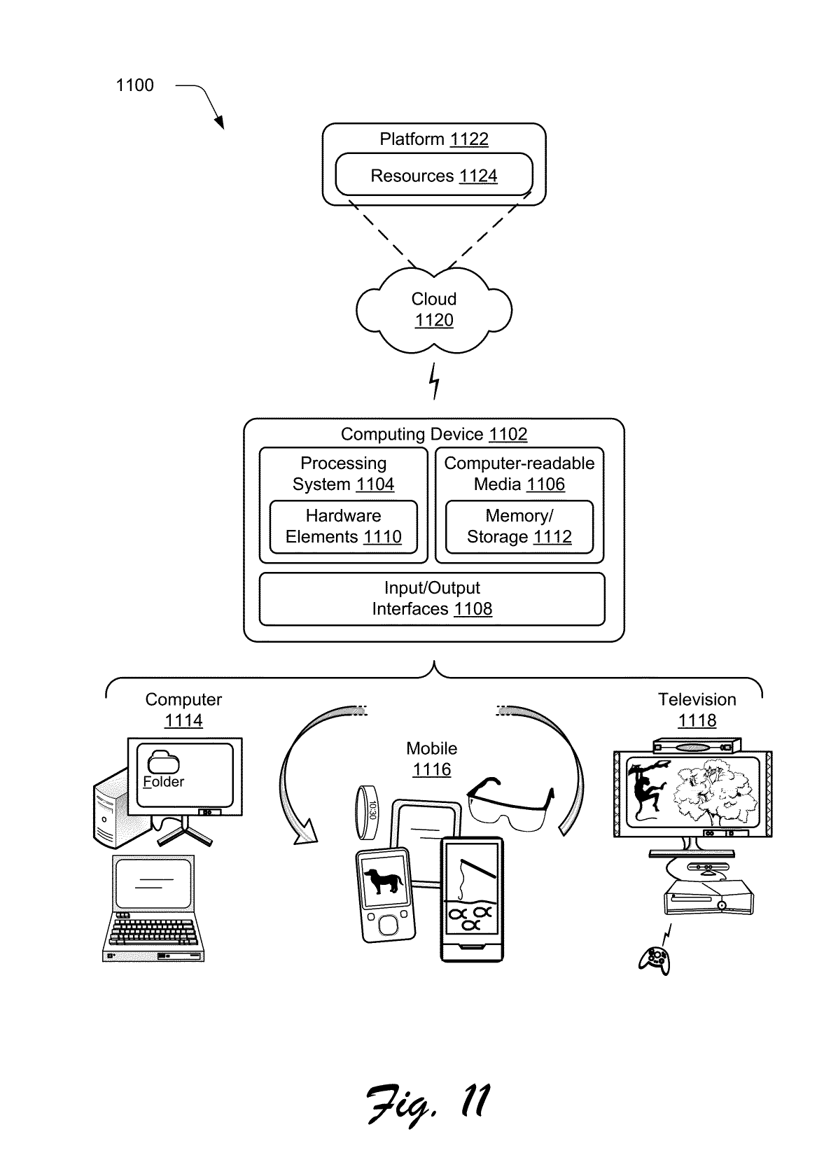

FIG. 1 is an illustration of an environment 100 in an example implementation that is operable to employ techniques for location information from a mobile device in accordance with one or more implementations. Environment 100 includes a client device 102 which can be embodied as any suitable device such as, by way of example and not limitation, a smartphone, a wearable device, a tablet computer, a portable computer (e.g., a laptop), a desktop computer, and so forth. One of a variety of different examples of the client device 102 is shown and described below in FIG. 10.

The client device 102 of FIG. 1 is illustrated as including a wireless module 104, which is representative of functionality to enable the client device 102 to communicate wirelessly with other devices and/or entities. The wireless module 104 can be configured to enable data communication via a variety of different wireless techniques and protocols. Examples of such techniques and/or protocols include cellular communications (e.g. 3G, 4G, Long Term Evolution (LTE), and so forth), near field communication (NFC), short-range wireless connections (e.g., Bluetooth), local area wireless networks (e.g., one or more standards in compliance with IEEE 802.11), wide area wireless networks (e.g., one or more standard in compliance with IEEE 802.16), wireless telephone networks, and so on.

The wireless module 104, for instance, includes hardware components that can be employed to enable the client device 102 to communicate wirelessly. Examples of such wireless hardware components include radio transmitters, radio receivers, various types and/or combinations of antennas, and so on. In at least some embodiments, the client device 102 is a multi-radio device that can communicate via different wireless technologies and/or protocols.

The client device 102 further includes a client location module 106 which is representative of functionality to enable the client device 102 to ascertain its location based on location information received from other devices. The client location module 106, for instance, can receive location information from source devices 108, and can process the location information in various ways to estimate a location of the client device 102.

The source devices 108 are representative of different devices that provide location information to the client device 102. The client device 102, for instance, communicates with the source devices 108 via a network 110. Alternatively or additionally, the client device 102 may communicate directly with the source devices 108, such as via direct wireless communication between the devices. The source devices 108 can be implemented as a variety of different device types such as, by way of example and not limitation, a smartphone, a tablet computer, a wearable device, a portable computer (e.g., a laptop), a desktop computer, and so forth. In at least some implementations, one or more of the source devices 108 are implemented as mobile end-user devices with which the client device 102 may interact to obtain location information. One of a variety of different examples of the source devices 108 is shown and described below in FIG. 10.

According to various implementations, the network 110 is representative of a single network or a combination of different interconnected networks. In at least some implementations, the network 110 includes different portions of the radio spectrum that may be leveraged for wireless communication. The network 110, for instance, may include a cellular network, a wireless broadband network (e.g., WiFi™), a satellite communication network, and so forth. The network 110 may also represent a combination of wireless and wired networks and may be configured in a variety of ways, such as a wide area network (WAN), a local area network (LAN), the Internet, and so forth. Accordingly, communication between the client device 102 and the source devices 108 may be implemented via a variety of different technologies (wired and wireless), such as wireless broadband, Bluetooth, cellular, and so forth.

The client location module 106 includes and/or has access to a location source database (DB) 112, which is representative of functionality to track various information for different source devices 108. For instance, the location source DB 112 may include identifiers for the source devices 108 and may track current and historic locations for the source devices 108, reliability of location information received from the source devices 108, and so forth.

According to various embodiments, the source devices 108 can communicate with position information systems 114 to obtain position information for the source devices 108. The position information systems 114 are representative of various types of position information systems that can transmit and/or receive position information. Examples of the position information systems 114 include GPS satellites, cellular telephone networks, wireless data (e.g., WiFi™) networks, radio frequency identifier (RFID) functionality, and so forth.

Position information, for example, can be communicated between the source devices 108 and the position information systems 114 to enable a location of the source devices 108 to be determined. Examples of position information include GPS coordinates, street addresses, network location, location with reference to a cell tower and/or set of cell towers, and so forth. As further detailed below, position information ascertained by the source devices 108 via interaction with the position information systems 114 can be communicated to the client device 102 to enable the client device 102 to estimate its location. The source devices 108, for instance, individually include a source location module 116 that is representative of functionality to ascertain a location of the source device 108 (e.g., based on interaction with the position information systems 114), and to propagate information about the location to the client location module 106 of the client device 102. The client location module 106 may process the location information in various ways to estimate a location of the client device 102.

The client device 102 further includes applications and services (“Applications”) 118, which are representative of functionalities to perform various tasks via the client device 102. As used herein, the term “applications” can refer to applications that are run locally and/or in a distributed environment, as well as services such as local services, web services, cloud-based services, and so forth. Examples of the applications 118 include a word processing application, a web browser, an email client, a communication service, a spreadsheet application, a content editing application, a web-based service portal, and so forth.

The applications 118, for instance, include a social network client 120. Generally, the social network client 120 is representative of functionality to enable different forms of social network interactions via the client device 102. The social network client 120, for instance, represents a portal to a social networking platform 122. According to various implementations, the social networking platform 122 represents a service that is accessible via the network 110 and that enables various social network interactions between the client device 102 and other devices. For instance, a user may interact with the social network client 120 to enable social network interaction with the social networking platform 122, such as for posting social networking content, viewing social networking content from other users (e.g., posts), and so forth. In at least some implementations, the social network client 120 may be implemented as an application installed on the client device 102, and/or as a portal to the social networking platform 122 that is accessible via the network 110.

The source devices 108 also include a social network client 124, which in at least some implementations, represents an instance of the social network client 120. A user of the client device 102, for instance, may interact with a user of the source device 108 via interaction between the social network client 120 and the social network client 124. As further detailed below, the client device 102 may detect that a source device 108 is nearby, which may trigger a social networking event between the social network client 120 and the social network client 124.

The environment 100 further includes remote services 126, which are representative of entities that provide different services to the client device 102 and the source devices 108. Examples of the remote services 126 include content-delivery services for providing content, such as for entertainment, education, shopping, advertising, and so forth. The remote services 126, for example, include the social networking platform 122 with which the client device 102 and the source devices 108 may interact. The remote services 126 may also include emergency services that can enable emergency assistance to be provided, such as police, emergency medical, fire department services, and so forth. According to various implementations, services provided by the remote services 126 can be focused and/or filtered based on a location of the client device 102.

For purposes of discussion herein, various entities may be referred to in both plural and singular implementations. Accordingly, a reference to singular implementation refers to an instance of the plural implementation. For instance, a reference to a single source device 108 refers to a particular instance of the source devices 108.

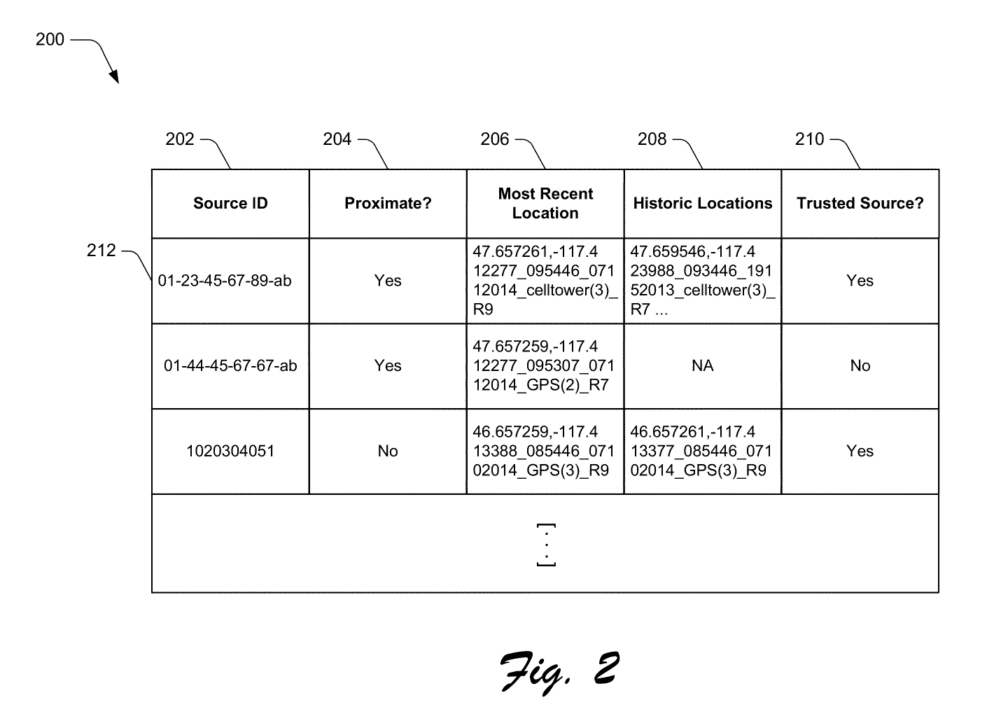

FIG. 2 illustrates an example location source table 200 in accordance with one or more implementations. The location source table 200, for instance, is implemented as part of the location source DB 112 to enable the client device 102 to track location-related attributes of different location sources, e.g., the source devices 108.

According to various implementations, the location source table 200 includes a source identifier (ID) column 202, a proximate column 204, a most recent location column 206, a historic locations column 208, and a trusted source column 210. The source ID column 202 includes identifiers for different location sources, such as device IDs for devices that provide location information. Example IDs that may be specified in the source ID column 202 include a media access control (MAC) address, a username, an internet protocol (IP) address, a mobile identification number (MIN), and so forth. Generally, the individual rows of the location source table 200 correspond to record entries for different location sources identified in the source ID column 202.

The proximate column 204 indicates whether a particular source is currently proximate to a device that is requesting location information. For instance, the proximate column 204 can indicate whether one or more of the source devices 108 are within a certain proximity to the client device 102. Proximity can be ascertained in various ways, such as via Bluetooth detection between devices, WiFi™ signal detection (e.g., based on signal strength, angle of arrival, and so forth), user input specifying that a device is nearby, and so forth. In at least some implementations, a threshold proximity can be specified such that location sources that are within the threshold proximity can be considered for providing location information, whereas location sources that are outside of the threshold proximity are not considered for providing location information.

The most recent location column 206 indicates most recently received location information from a location source. Various values may be indicated in the most recent location column 206, such as GPS coordinates, street address, a facility-based location (e.g., a building identifier, a room identifier, and so forth), a landmark-based location (e.g., “in the Space Needle”), and so forth. In this particular example, location information specified in the most recent location column 206 includes a location string that includes various position-related information. For instance, the location string includes a location value, a time value which specifies a time at which the location value was detected by the location source (e.g., based on interaction with the position information systems 114), a date value that specifies a date on which the location value was detected by the location source, a position information system/systems 114 that the location information is based on, and a reliability value for the location information.

For instance, consider the location information specified for the most recent location column 206 for the location source specified in the row 212. The location information specifies GPS coordinates of 47.657261, −117.412277 that were collected at a time of 9:54:46 on Jul. 12, 2014 (07.12.2014). The location information further specifies that the location information was determined based on cellular triangulation using 3 cell towers and with a reliability value of 9.

The historic locations column 208 specifies location information for previous locations of a location source. In at least some implementations, location information specified in the historic locations column 208 can be used along with location information from the most recent location column 206 to estimate a location of a requesting device.

The trusted source column 210 identifies whether a particular location source identified in the source ID column 202 is a trusted source, e.g., has a validated trust relationship with a requesting device. As further detailed below, certain types of content may be shared among devices that share a trust relationship, such as social media content, personal communications, and so forth.

The example location-related attributes specified by the location source table 200 are presented for purpose of example only, and it is to be appreciated that a variety of other attributes and values may be specified for location sources in accordance with one or more embodiments. For instance, the location source table 200 may specify other attributes of location sources, such source type (e.g., device type), applications and services available at a location source, communication technologies supported by a source device (e.g., WiFi™, Bluetooth, cellular, and so on), and so forth.

Having described an example environment in which the techniques described herein may operate, consider now a discussion of some example implementation scenarios in accordance with one or more embodiments.

Example Implementation Scenarios

The following discussion describes example implementation scenarios for location information from a mobile device in accordance with one or more embodiments. In portions of the following discussion, reference will be made to the environment 100 of FIG. 1.

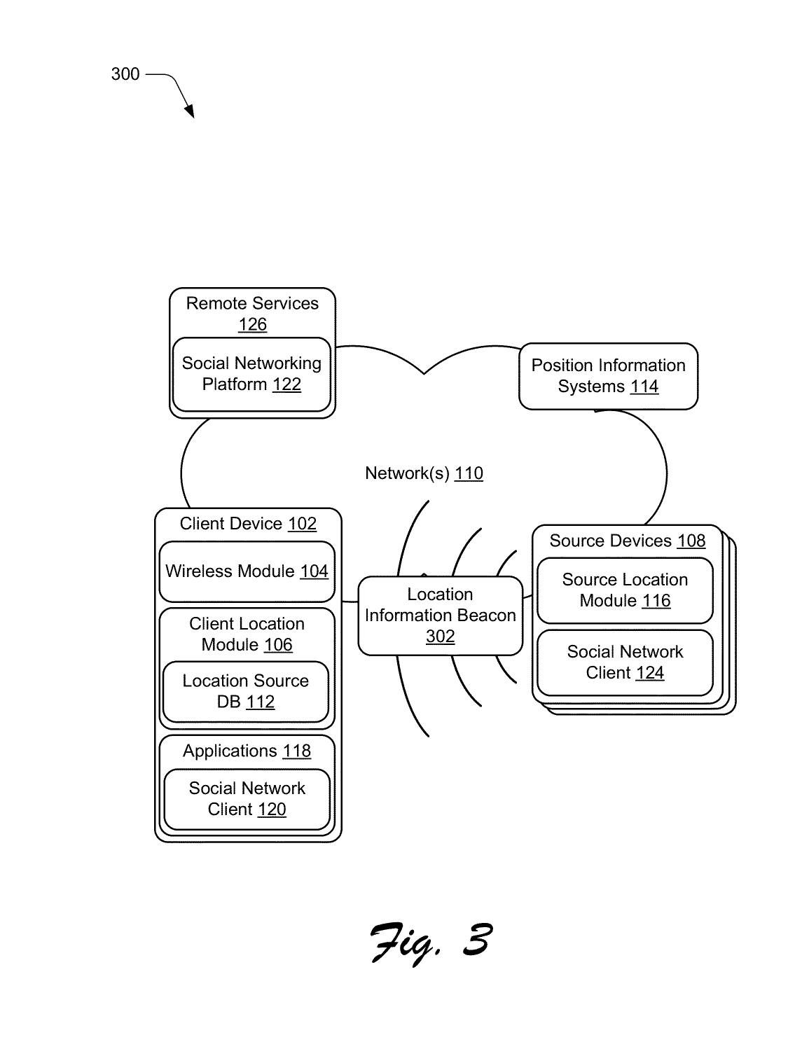

FIG. 3 illustrates an example implementation scenario 300 for receiving location information in accordance with one or more embodiments. In the scenario 300, a source device 108 transmits a location information beacon 302 that includes location information ascertained by the source device 108. The location information beacon 302 can be implemented in various ways, such as an information element of a wireless beacon that identifies the location information beacon 302 as being location-related and that includes various types of location information, examples of which are discussed throughout.

In at least some implementations, the location information beacon 302 can be emitted by the source device 108 proactively, e.g., automatically and not in response to a query for location information. For instance, the source device 108 may periodically determine its location based on interaction with the position information systems 114 and may periodically (e.g., every 500 milliseconds (ms)) transmit the location information beacon 302 with information pertaining to the location.

Continuing with the scenario 300, the client device 102 receives the location information beacon 302 and parses the beacon to identify the location information included therein. For instance, the client location module 106 periodically monitors for location information being transmitted by location sources, and thus detects the location information beacon 302. The client device 102 uses the location information to ascertain its own location. Example ways of ascertaining device location based on received location information are detailed elsewhere herein. According to various implementations, the client device 102 uses the location information from the location information beacon 302 to create and/or update a source record for the source device 108, such via an entry in the location source table 200.

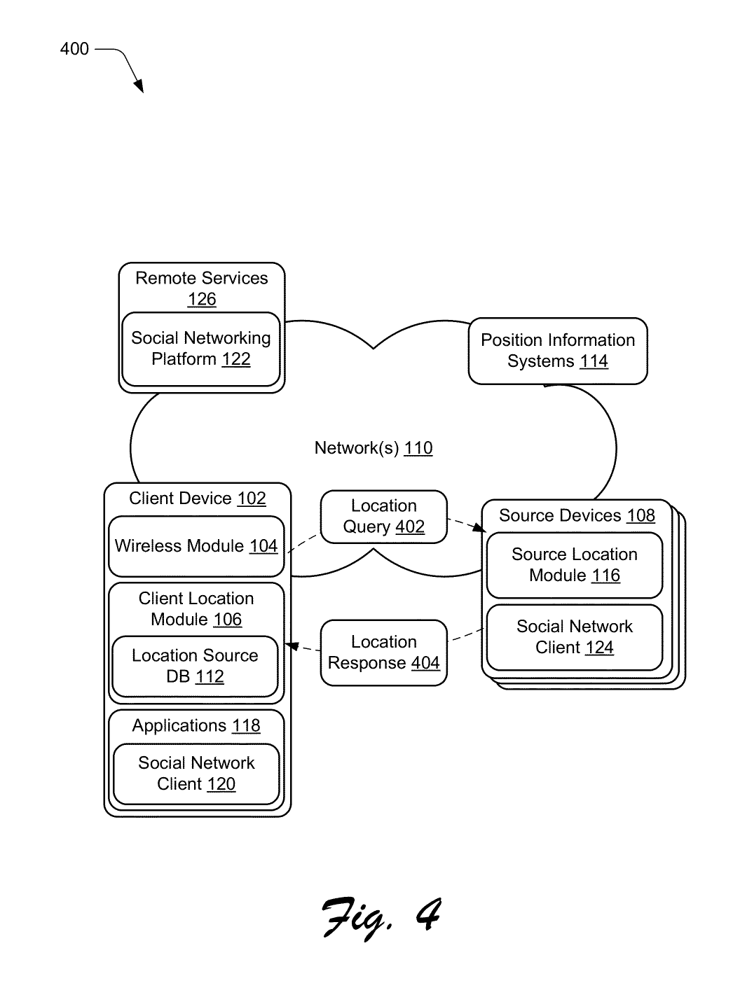

FIG. 4 illustrates an example implementation scenario 400 for querying for location information in accordance with one or more embodiments. In the scenario 400, the client device 102 transmits a location query 402 that requests location information from a location source in its proximity. The location query 402, for instance, includes an identifier for the client device 102 and indicates that the client device 102 is requesting location information.

According to various implementations, the location query 402 may be directed to a particular location source, such as a particular instance of a source device 108. For example, the client device 102 may detect that the source device 108 is nearby (e.g., within a pre-specified proximity) and thus may direct the location query 402 to the source device 108. Alternatively or additionally, the location query 402 may be formatted as a general query to any source device 108 within a particular proximity of the client device 102.

Further to the scenario 400, the source device 108 receives the location query 402 and ascertains that includes a request from the client device 102 for location information. Accordingly, the source device 108 generates a location response 404 that it includes location information for the source device 108. For instance, the source device 108 interacts with a particular position information system 114 to estimate its own location. The source device 108 then populates the location response 404 with position information that describes an estimated location of the source device 108. Examples of different types of position information are detailed elsewhere herein.

Continuing with the scenario 400, the source device 108 communicates the location response 404 to the client device 102. The client device 102 parses the location response 404 and identifies the location information included therein. The client device 102 uses the location information to estimate its own location, such as detailed elsewhere herein.

According to various implementations, the scenario 400 represents an additional or an alternative implementation to the implementation discussed with reference to the scenario 300. For example, in at least some implementations, a device that seeks to estimate its location need not communicate a specific query for communication information (e.g., the location query 402), but may simply detect location information that is emitted by a location source, e.g., via the location information beacon 302. Alternatively or additionally, a requesting device may receive location information in response to a specify query for the location information, e.g., the location query 402. Thus, in at least some implementations, a source device 108 does not transmit location information unless it receives the location query 402.

Having discussed some example implementation scenarios, consider now some example ways of determining and specifying location information accuracy in accordance with one or more embodiments.

Location Information Reliability

The following discussion describes example ways of determining and specifying location information accuracy in accordance with one or more embodiments. These examples are not intended to be exhaustive but are presented for purpose of illustration only.

According to various implementations, reliability values may be specified in a variety of different ways. For instance, location information reliability may be specified in general terms, such a high, medium, and low. Alternatively or additionally, reliability may be based on a reliability scale, such as 1-10, with 10 corresponding the high-reliability location information, and 1 corresponding to very low-reliability location information. Alternatively or additionally, reliability may be specified in terms of a margin of error, e.g., a distance within which location information is considered to be accurate. For instance, location information may be specified as a particular position accompanied by an accuracy range, such as +/−10 meters, +/−25 meters, +/−50 meters, and so forth. Reliability values may also be combined to provide a more detailed representation of location information accuracy. A variety of other reliability indicators may utilized in accordance with the described implementations.

Cellular Location Information—Location information may be based on interaction with a cellular network, such as via cellular triangulation of a source device. Reliability of cellular location information may be based on various factors, such as a number of cell towers used to ascertain the location information, angle of separation of the cell towers relative to the source device (e.g., tower geometry relative to the source device), signal strength of the cellular signal between the cell towers and the source device, and so on. For instance, consider the following example characterizations:

High-Reliability Cellular Location Information: High-reliability cellular location information may be based on cellular triangulation that involves three or more cell towers with favorable tower geometry and with high signal strength and high signal quality. For instance, high-reliability cellular location information may be associated with a reliability value of 8-10.

Medium-Reliability Cellular Location Information: Medium-reliability cellular location information may be based on cellular triangulation that involves two or three cell towers with favorable tower geometry and with medium signal strength and medium signal quality. For instance, medium-reliability cellular location information may be associated with a reliability value of 5-7.

Low-Reliability Cellular Location Information: Low-reliability cellular location information may be based on cellular triangulation that is based on two cell towers with poor tower geometry. For instance, low-reliability cellular location information may be associated with a reliability value of less than 5.

GPS Location Information—Location information may be based on interaction with a GPS system, such as multiple GPS satellites. Reliability of GPS location information may be based on various factors, such as a number of GPS satellites used to ascertain the location information, signal strength and signal quality of the GPS signal between the satellites and the source device, and so on. For instance, consider the following example characterizations:

High-Reliability GPS Location Information: High-reliability GPS location information may be based on GPS information that involves three or more satellites with high signal strength and high signal quality. For instance, high-reliability GPS location information may be associated with a reliability value of 8-10.

Medium-Reliability GPS Location Information: Medium-reliability GPS location information may be based on GPS information that involves two or three satellites with medium signal strength and medium signal quality. For instance, medium-reliability GPS location information may be associated with a reliability value of 5-7.

Low-Reliability GPS Location Information: Low-reliability GPS location information may be based on GPS information that is based on two or fewer GPS satellites with poor signal strength. For instance, low-reliability GPS location information may be associated with a reliability value of less than 5.

Similar metrics as those discussed above may be used for a variety of position information systems, such as wireless broadband access points, radio-frequency identification (RFID) systems, optical-based location systems, and so forth.

Having discussed some example ways of determining and specifying location information accuracy, consider now some example procedures in accordance with one or more embodiments.

Example Procedures

This section describes some example procedures for performing different aspects of techniques for location information from a mobile device discussed herein. The procedures, for instance, describe example ways of implementing different aspects of the implementation scenarios described above.

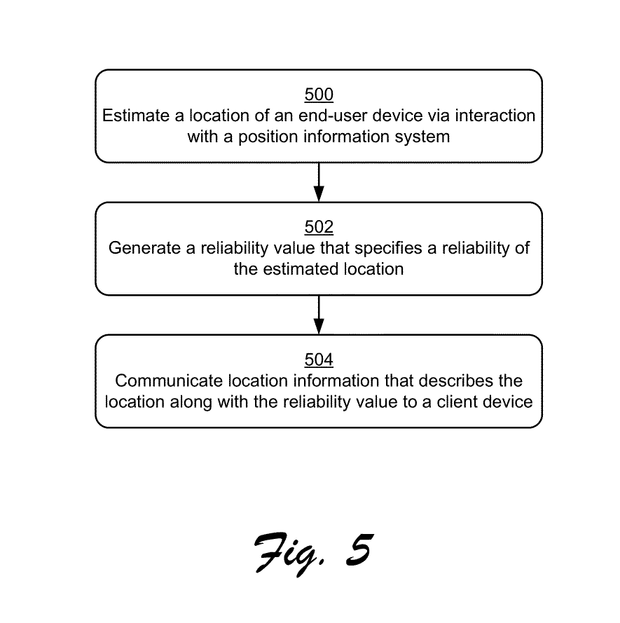

FIG. 5 is a flow diagram that describes steps in a method for communicating location information in accordance with one or more implementations. In at least some implementations, the method can be performed by a location source, such as a source device 108.

Step 500 estimates a location of an end-user device via interaction with a position information system. The source device 108, for instance, interacts with one or more of the position information systems 114 to estimate a location of the source device 108. In at least some implementations, step 500 can be performed periodically, e.g., independent of a query from another client device for location information. Alternatively or additionally, step 500 can be performed in response to a query from another device for position information, e.g., from the client device 102.

Step 502 generates a reliability value that specifies a reliability of the estimated location. As discussed above, reliability of location information may be based on various factors, such as attributes of a position information system utilized to obtain the location information. The reliability value, for instance, may specify whether the estimated location has a high, medium, or low likelihood of being accurate. In at least some implementations, a reliability value may specify an accuracy range, e.g., that the estimated location is accurate to within a particular distance, such as 20 meters, 50 meters, and so forth.

Step 504 communicates location information that describes the location along with the reliability value to a client device. A source device 108, for instance, can transmit the location information in a location-related beacon. The beacon, for instance, can be transmitted (e.g., periodically) and independent of a query from a client device for location information. Alternatively or additionally, the location information may be transmitted in a response to a query from the client device 102 for location information.

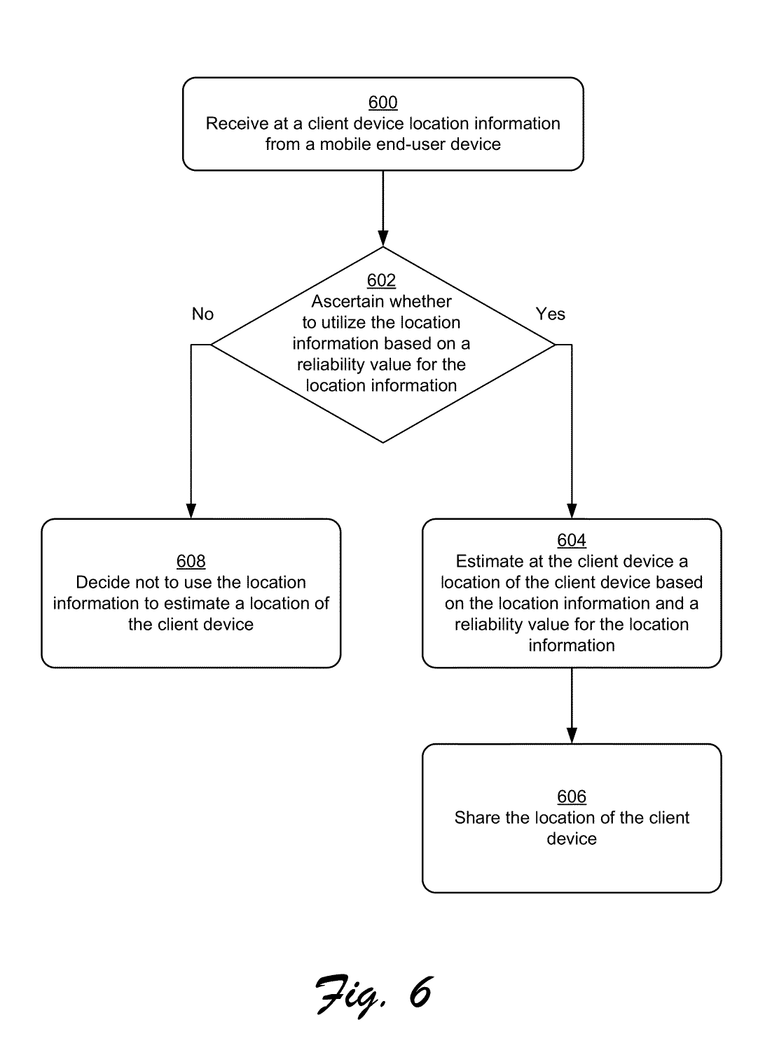

FIG. 6 is a flow diagram that describes steps in a method for estimating device location based on location information received from a source device in accordance with one or more implementations. In at least some implementations, the method can be performed by a client device, such as the client device 102.

Step 600 receives at a client device location information from a mobile end-user device. The client device 102, for instance, can detect location information transmitted by the source device 108 in a location-related beacon. Alternatively or additionally, the client device 102 can submit a location query to the source device 108, which can return a query response that includes location information along with a reliability value for the location information.

Step 602 ascertains whether to utilize the location information based on a reliability value for the location information. The reliability value, for instance, can be received along with the location information, such as from a source of the location information. Alternatively or additionally, reliability values may be assigned by the receiving device (e.g., the client device 102), such as based on attributes of the location information. For instance, the location information may be received with information that identifies attributes of position information systems utilized to obtain the location information. Thus, the receiving device may assign reliability values based on the attributes of the position information systems.

If the location information is to be utilized (“Yes”), step 604 estimates at the client device a location of the client device based on the location information and a reliability value for the location information. The client device, for instance, can estimate its own location as corresponding to the location information, such as based on GPS coordinates, street address, landmark location, and so forth. Alternatively or additionally, the client device may apply a correction factor to the location information that accounts for an estimated distance between the client device and the source end-user device.

According to various implementations, how the location information is utilized may be based on the reliability value. For instance, the location information may be ranked relative to other location information based on the reliability value. Alternatively or additionally, the location information may be combined with other location information (e.g., of the same or higher reliability value) to estimate location. For instance, the location information may be combined and/or compared to location information from other end-user devices to estimate a location of the client device 102.

In at least some implementations, the location information received from the mobile end-user device can be combined and/or contrasted with location information determined at the client device to estimate a location of the client device. For instance, the client device 102 may interact with a position information system 114 to attempt to ascertain its own location information. The client device 102 may then utilize the location information received from a source device 108 to verify and/or correct its own location information. As an example, consider a scenario where the client device 102 determines that its own location information has a low reliability value. The client device 102 may utilize location information from a source device 108 to verify and/or correct its own location information. Thus, in at least some implementations, location information received from a remote device may be utilized in combination with other location information to estimate a location of the client device 102.

Step 606 shares the location of the client device. The client device 102, for instance, may share its location with other devices, applications, services, and so forth. For instance, if the client device 102 ascertains that a device is a trusted device, the client device 102 may share its location with the trusted device. As another example, certain applications and services may be designated as trusted, and thus the location of the client device 102 may be shared with the trusted applications and/or trusted services. For instance, a user of the client device 102 may specify that a social networking platform is trusted, and thus the location of the client device 102 may be posted to the social networking platform.

If the location information is not to be utilized (“No”), step 608 decides not to use the location information to estimate a location of the client device. For instance, if the reliability value for the location information is low, the client device 102 may decide that the location information is too unreliable to be relied upon for accurate location information. As detailed below, a reliability threshold may be employed to ascertain whether location information is sufficiently reliable to be utilized to estimate location. In at least some implementations, location information that falls below a particular reliability value and/or reliability threshold may be ignored for purposes of estimating location.

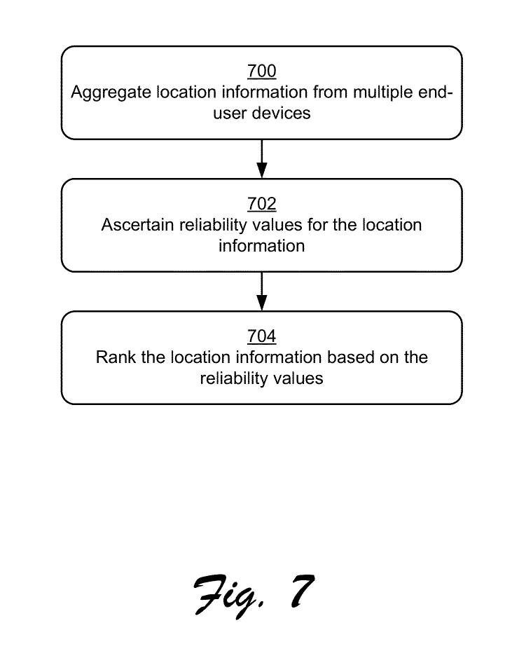

FIG. 7 is a flow diagram that describes steps in a method for ranking location information in accordance with one or more implementations. In at least some implementations, the method can be performed by a client device, such as the client device 102.

Step 700 aggregates location information from multiple end-user devices. The client device 102, for instance, receives location information from multiple different source devices 108.

Step 702 ascertains reliability values for the location information. For instance, location information may be received with reliability values already assigned. Alternatively or additionally, reliability values may be assigned after the location information is received, such as based on parameters that specify how the location information was ascertained by a location source.

Step 704 ranks the location information based on the reliability values. For instance, the location information may be ranked in descending order of reliability. Higher-ranked location information, for example, may be prioritized over lower-ranked location information, such as for purposes of estimating a location of a requesting device.

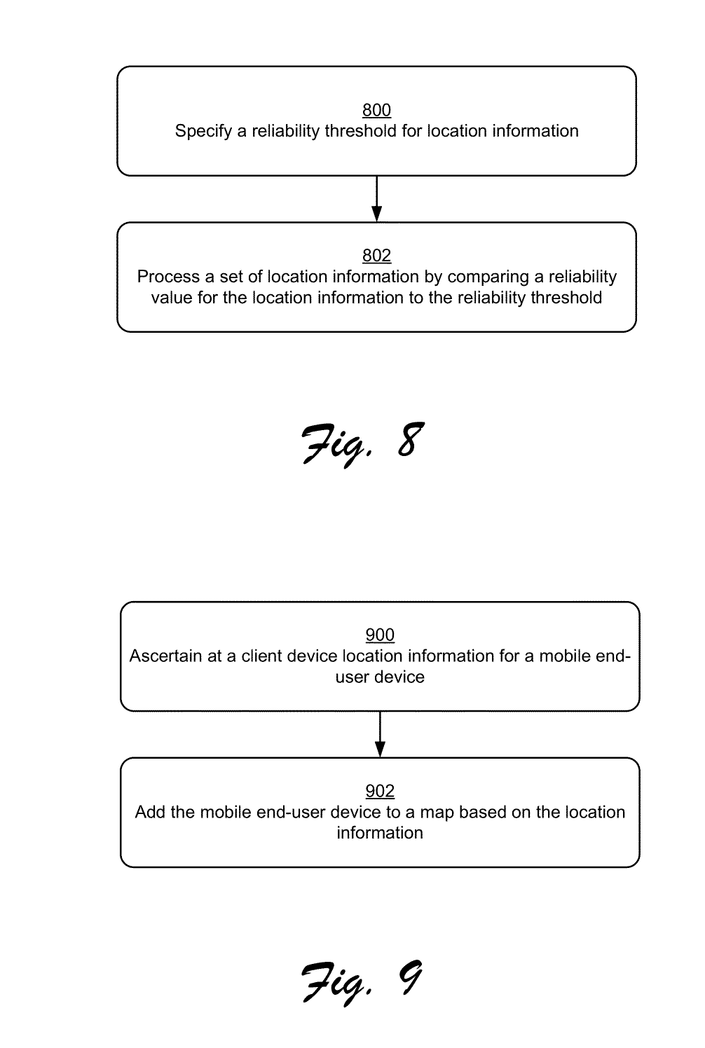

FIG. 8 is a flow diagram that describes steps in a method for processing location information based on a reliability threshold in accordance with one or more implementations. In at least some implementations, the method can be performed by a client device, such as the client device 102.

Step 800 specifies a reliability threshold for location information. The reliability threshold, for instance, may be specified based on a reliability value of a reliability scale. For instance, if a numerical reliability scale is implemented, a discrete reliability value may be specified as the reliability threshold. As an example, consider the 1-10 reliability scale discussed above. In such an implementation, a reliability threshold of 6 may be specified. In another example that uses general reliability indicators (e.g., low, medium, high), a “medium” reliability threshold may be specified. These reliability scales and thresholds are provided for purpose of example only, and it is to be appreciated that a variety of different reliability scales and thresholds may be utilized in accordance with the described implementations.

Step 802 processes a set of location information by comparing a reliability value for the location information to the reliability threshold. For instance, location information with a reliability value below the threshold may be ignored for purposes of estimating location. In at least some implementations, a ranked set of location information (e.g., as detailed above) may be filtered using the reliability threshold. For instance, location information that meets or exceeds the reliability threshold may be utilized to estimate location, whereas location information below the reliability threshold may be determined to not be sufficiently reliable for estimating location.

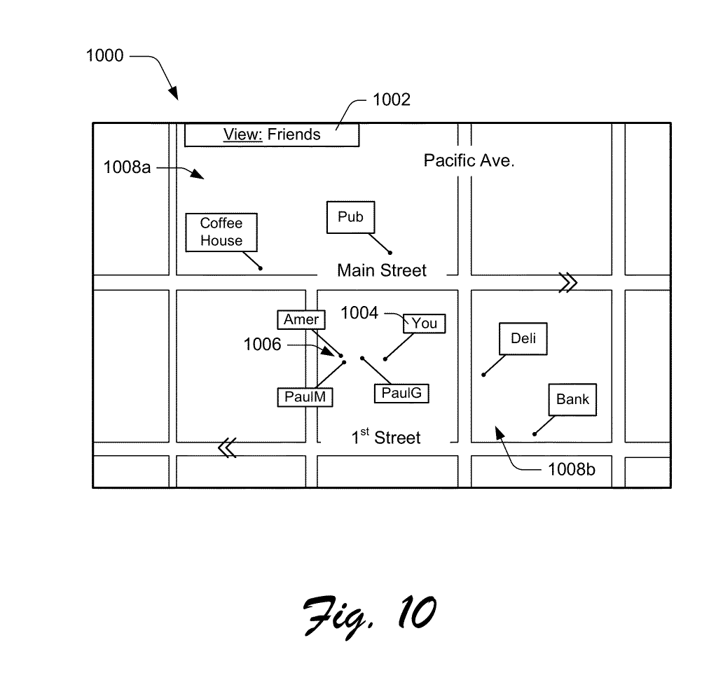

FIG. 9 is a flow diagram that describes steps in a method for mapping devices based on location information received from a source device in accordance with one or more implementations. In at least some implementations, the method can be performed by a client device, such as the client device 102.

Step 900 ascertains at a client device location information for a mobile end-user device. The client device 102, for instance, can detect location information transmitted by the source device 108 in a location-related beacon. Alternatively or additionally, the client device 102 can submit a location query to the source device 108, which can return a query response that includes location information along with a reliability value for the location information. Various other ways of ascertaining a location of the mobile end-user devices may be employed in accordance with various implementations.

Step 902 adds the mobile end-user device to a map based on the location information. The client device 102, for instance, maintains a map of different end-user devices. For example, end-user devices that are identified as having a trust relationship with the client device 102 may be mapped, such as a “friends” map that indicates locations of different friend devices. In at least some implementations, a graphical user interface (GUI) may be displayed that includes a map of different end-user device locations, such as a visual mapping of friend devices according to location. One example of such a map is described below.

Having discussed some example procedures, consider now a discussion of an example proximity map in accordance with one or more embodiments.

Example Proximity Map

FIG. 10 illustrates an example proximity map 1000 in accordance with one or more implementations. Generally, the proximity map 1000 displays estimated locations of different entities in a particular geographical region, such as based on locations estimated according to techniques discussed herein. The proximity map 1000, for instance, represents a map that is implemented according to the method discussed above with reference to FIG. 9.

Included as part of the proximity map 1000 is a view indicator 1002, which identifies parameters for a particular view presented by the proximity map 1000. In this particular example, the view indicator 1002 specifies that “friends” are displayed in the proximity map 1000. A user, for instance, specifies a setting for the proximity map 1000 that indicates that identifiers for friends that are in a particular proximity of the user are to be displayed as part of the proximity map 1000. According to various implementations, a user may specify a variety of different filters that may be applied to determine which types and instances of entities are to be displayed as part of the proximity map 1000.

The proximity map 1000 further includes a user indicator 1004 (e.g., “You”) and friend indicators 1006, e.g., “Amer,” “PaulM,” and “PaulG.” The user indicator 1004, for instance, specifies a location of a user device that is determined according to techniques for location information from a mobile device. For instance, the location for the user indicator 1004 is determined based on location information from one or more mobile devices associated with the users identified at the friend indicators 1006. According to one or more implementations, the user indicator 1004 corresponds to a location of the client device 102 at a particular time.

In at least some implementations, the friend indicators 1006 correspond to users who are identified as social networking “friends,” e.g., in relation to the social networking platform 122. Locations for the friend indicators 1006 can be determined in various ways, such as via inter-device proximity detection between a user device and friend devices, information shared among devices via the social networking platform 122, communication events propagated between devices, and so forth. According to one or more implementations, the friend indicators 1006 correspond to locations of one or more of the source devices 108 at a particular time.

The proximity map 1000 further includes landmark indicators 1008a (e.g., “Coffee House” and “Pub”) and landmark indicators 1008b, e.g., “Deli” and “Bank.” Generally, the landmark indicators 1008a, 1008b identify different locations that may be of interest. In at least some implementations, location information used to place one or more of the landmark indicators 1008a, 1008b may be received from an associated landmark entity. For instance, the Coffee House may communicate its location, such as via a location beacon, location information posted to a social networking site, and so forth. Thus, one or more of the landmark indicators 1008a, 1008b may be positioned based on real-time location information. According to various implementations, a user may specify filtering criteria that may be used to filter which types of landmarks are displayed as part of the proximity map 1000, such as “food and drink,” “entertainment,” “shopping,” “sports,” and so forth.

According to one or more implementations, the different location indicators are selectable to initiate various types of actions. For instance, the friend indicators 1006 are individually selectable to initiate a communication event with an associated user, such as an instant message, a chat, an email, a social networking message (e.g., via the social networking platform 122), a communication session (e.g., a Voice over Internet Protocol (VoIP) call), and so forth. The landmark indicators 1008a, 1008b may be individually selectable to retrieve information about associated landmarks, such as directions, a web page, contact information, a social networking site, and so forth. A variety of other actions are contemplated in accordance with the claimed implementations.

The proximity map 1000 may be periodically refreshed (e.g., according to a specified refresh rate) to update locations of different entities, such as friends that are within a particular proximity For instance, the proximity map 1000 may be refreshed based on source devices 108 identified in the location information beacon 302 and/or in a location response 404. Alternatively or additionally, a user may initiate a refresh of the proximity map 1000, such as by selecting a refresh control.

Having discussed an example proximity map, consider now a discussion of an example system and device in accordance with one or more embodiments.

Example System and Device

FIG. 11 illustrates an example system generally at 1100 that includes an example computing device 1112 that is representative of one or more computing systems and/or devices that may implement various techniques described herein. For example, the client device 102 and/or the source devices 108 discussed above with reference to FIG. 1 can be embodied as the computing device 1102. The computing device 1102 may be, for example, a server of a service provider, a device associated with the client (e.g., a client device), an on-chip system, and/or any other suitable computing device or computing system.

The example computing device 1102 as illustrated includes a processing system 1104, one or more computer-readable media 1106, and one or more I/O Interfaces 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware element 1110 that may be configured as processors, functional blocks, and so forth. This may include implementation in hardware as an application specific integrated circuit or other logic device formed using one or more semiconductors. The hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1106 is illustrated as including memory/storage 1112. The memory/storage 1112 represents memory/storage capacity associated with one or more computer-readable media. The memory/storage 1112 may include volatile media (such as random access memory (RAM)) and/or nonvolatile media (such as read only memory (ROM), Flash memory, optical disks, magnetic disks, and so forth). The memory/storage 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone (e.g., for implementing voice and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of modules as a module that is executable by the computing device 1102 as software may be achieved at least partially in hardware, e.g., through use of computer-readable storage media and/or hardware elements 1110 of the processing system. The instructions and/or functions may be executable/operable by one or more articles of manufacture (for example, one or more computing devices 1102 and/or processing systems 1104) to implement techniques, modules, and examples described herein.

As further illustrated in FIG. 11, the example system 1100 enables ubiquitous environments for a seamless user experience when running applications on a personal computer (PC), a television device, and/or a mobile device. Services and applications run substantially similarly in all three environments for a common user experience when transitioning from one device to the next while utilizing an application, playing a video game, watching a video, and so on.

In the example system 1100, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1102 may assume a variety of different configurations, such as for computer 1114, mobile 1116, and television 1118 uses. Each of these configurations includes devices that may have generally different constructs and capabilities, and thus the computing device 1102 may be configured according to one or more of the different device classes. For instance, the computing device 1102 may be implemented as the computer 1114 class of a device that includes a personal computer, desktop computer, a multi-screen computer, laptop computer, netbook, and so on.

The computing device 1102 may also be implemented as the mobile 1116 class of device that includes mobile devices, such as a mobile phone, a wearable device, portable music player, portable gaming device, a tablet computer, a multi-screen computer, and so on. The computing device 1102 may also be implemented as the television 1118 class of device that includes devices having or connected to generally larger screens in casual viewing environments. These devices include televisions, set-top boxes, gaming consoles, and so on.

The techniques described herein may be supported by these various configurations of the computing device 1102 and are not limited to the specific examples of the techniques described herein. For example, functionalities discussed with reference to the client device 102 and/or the source devices 108 may be implemented all or in part through use of a distributed system, such as over a “cloud” 1120 via a platform 1122 as described below.

The cloud 1120 includes and/or is representative of a platform 1122 for resources 1124. The platform 1122 abstracts underlying functionality of hardware (e.g., servers) and software resources of the cloud 1120. The resources 1124 may include applications and/or data that can be utilized while computer processing is executed on servers that are remote from the computing device 1112. Resources 1124 can also include services provided over the Internet and/or through a subscriber network, such as a cellular or Wi-Fi™ network.

The platform 1122 may abstract resources and functions to connect the computing device 1112 with other computing devices. The platform 1122 may also serve to abstract scaling of resources to provide a corresponding level of scale to encountered demand for the resources 1124 that are implemented via the platform 1122. Accordingly, in an interconnected device embodiment, implementation of functionality described herein may be distributed throughout the system 1100. For example, the functionality may be implemented in part on the computing device 1112 as well as via the platform 1122 that abstracts the functionality of the cloud 1120.

Discussed herein are a number of methods that may be implemented to perform techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

### CONCLUSION

Techniques for location information from a mobile device are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

1. A system comprising:
one or more processors; and
one or more computer-readable storage media storing computer-executable instructions that are executable by the one or more processors to perform operations including:
receiving at a client device location information from a mobile end-user device; and
estimating at the client device a location of the client device based on the location information and a reliability value for the location information said estimating including:
comparing the reliability value to a different reliability value for different location information received from a different end-user device; and
prioritizing the location information over the different location information based on the reliability value indicating that the location information has a higher reliability than the different location information.

2. A system as described in claim 1, wherein the location information is detected in a beacon transmitted by the mobile end-user device and independent of a query by the client device.

3. A system as described in claim 1, wherein the location information is received as part of a response to a query by the client device.

4. A system as described in claim 1, wherein the location information identifies at least one position information system that was leveraged to obtain the location information.

5. A system as described in claim 1, wherein the reliability value is received from the mobile end-user device.

6. A system as described in claim 1, wherein the reliability value is assigned to the location information at the client device.

7. (canceled)

8. A system as described in claim 1, wherein the operations further include sharing the location of the client device with one or more of a different end-user device or a network service.

9. A system as described in claim 1, wherein the operations further include adding an indicator that identifies a user of the mobile end-user device to a map that is displayed at the client device, the indicator being positioned according to the location information received from the mobile end-user device.

10. A system as described in claim 9, wherein the indicator is selectable to initiate a communication event with the mobile end-user device.

11. A computer-implemented method comprising:
estimating a location of an end-user device via interaction with at least one position information system;
generating a reliability value that specifies a reliability of the estimated location, said generating performed at least in part using one or more attributes of the at least one position information system; and
communicating location information that describes the location along with the reliability value to a client device.

12. The computer-implemented method as described in claim 11, wherein said communicating comprises transmitting a beacon that includes the location information and independent of a query from the client device for the location information.

13. The computer-implemented method as described in claim 11, wherein said communicating communicating the location information in response to a query from the client device for the location information.

14. (canceled)

15. The computer-implemented method as described in claim 11, wherein said generating is based on at least one of:
a number of cell towers of the at least one position information system utilized to estimate the location of the end-user device; or
a number of satellites of the at least one position information system utilized to estimate the location of the end-user device.

16. A computer-implemented method comprising:
receiving at a client device location information from a mobile end-user device; and
ascertaining at the client device whether or how to estimate a location of the client device based on a reliability value for the location information, said ascertaining including:
ranking the location information relative to other location information utilizing the reliability value;
selecting the location information based on the location information ranking higher than the other location information; and
estimating at the client device a location of the client device based on the location information and the reliability value for the location information.

17. (canceled)

18. The computer-implemented method as described in claim 16, wherein said ascertaining comprises:
determining that the reliability value is above a reliability threshold; and
deciding, in response to said determining, to use the location information to estimate the location of the client device.

19. The computer-implemented method as described in claim 16, further comprising:
sharing the location of the client device with one or more of a different client device or a social networking platform.

20. The computer-implemented method as described in claim 16, further comprising causing a map to be displayed that includes an estimated location of the client device and an indicator that identifies a user of the mobile end-user device, the indicator being positioned based on the location information.

21. A system as described in claim 1, wherein the operations further include:
determining that the reliability value is above a reliability threshold; and
deciding, in response to said determining, to use the location information to estimate the location of the client device.

22. The computer-implemented method as described in claim 11, wherein said communicating is performed in response to ascertaining that the client device is a trusted device.

23. The computer-implemented method as described in claim 16, further comprising causing a map to be displayed that includes an estimated location of the client device and an indicator that identifies a user of the mobile end-user device, the indicator being positioned based on the location information and being selectable to initiate a communication event with the mobile end-user device.
